(19) United States
(12) Patent Application Publication
(10) Pub. No.: US 2011/0234542 A1
(43) Pub. Date: Sep. 29, 2011

(54) Methods and Systems Utilizing Multiple Wavelengths for Position Detection

(76) Inventor: Paul Marson, Auckland (NZ)

(21) Appl. No.: 13/071,842

(22) Filed: Mar. 25, 2011

(30) Foreign Application Priority Data
Mar. 26, 2010 (AU) 2010901367

(51) Int. Cl. G06F 3/042; G01C 21/00; G01B 11/14

(52) U.S. Cl. 345/175; 250/206.1; 356/614; 356/623

(57) ABSTRACT

A position detection system can utilize multiple optical responses to a detection scene, such as by using multiple different patterns of light for imaging a given detection scene. The multiple patterns can include a first pattern containing image data that can be used to separate reflected light from retroreflected light in a second pattern of light. This can be used to reduce errors, such as false detections due to directly-reflected light, and/or can be used for identification of objects in the touch detection scene when the objects themselves are optically configured to appear differently in different patterns of light.

### PRIORITY CLAIM

This application claims priority to Australian Provisional Patent Application No. 2010901367, filed Mar. 26, 2010, naming inventor Paul Marson and titled, “A Position detection Device Utilizing Light of Different Wavelengths,” which is incorporated by reference herein in its entirety.

### BACKGROUND

Optical touch systems function by having at least one optical sensor that detects energy such as light in a touch detection area. For instance, some optical touch systems emit light into the touch detection area so that, in the absence of an object in the touch detection area, the sensor will register light retroreflected from a border of the touch area or otherwise returned to the sensor. Data from the sensor can be used to identify a reduction in the pattern of returned light and, based on the characteristics of the reduction and the geometry of the touch system, determine a location of the touch or other, non-touch, activity in the detection area (e.g., by triangulation or other methods).

### SUMMARY

A position detection system can utilize multiple optical responses to a detection scene, such as by using multiple different types of light to illuminate the detection scene and imaging the resulting patterns of light. The multiple patterns can include a first pattern containing image data that can be used to separate reflected light from retroreflected light in a second pattern of light. This can be used to reduce errors, such as false detections due to directly-reflected light, and/or can be used for identification of objects in the touch detection scene when the objects themselves are optically configured to appear differently in different patterns of light.

In some implementations, a position detection system can use different wavelengths of light, such as by directing a first wavelength of light that is retroreflected by components in the touch area and directing a second wavelength of light that is not retroreflected by the components in the touch area. A second pattern of light returned due to the second wavelength of light can be subtracted from a first pattern of light returned due to the first wavelength of light. For example, the touch area may be configured so that light of the first wavelength is retroreflected by fixed components in the touch area but light of the second wavelength is not retroreflected. In that case, because the second pattern of light will not include retroreflected light, subtraction of that pattern will reduce or remove directly-reflected light from the first pattern of light.

These illustrative examples are discussed not to limit the present subject matter, but to provide a brief introduction. Objects and advantages of the present subject matter can be determined upon review of the specification and/or practice of an embodiment configured in accordance with one or more aspects taught herein.

### BRIEF DESCRIPTION OF THE DRAWINGS

A full and enabling disclosure is set forth more particularly in the remainder of the specification. The specification makes reference to the following appended figures.

FIG. 1A is a diagram showing an illustrative position detection system.

FIG. 1B is a graph showing a distribution of detected light due to an object blocking light from being reflected by components of the position detection system.

FIG. 2A is a diagram showing the illustrative position detection system when an object is close to an optical detector, while FIG. 2B shows the corresponding distribution of light as detected.

FIG. 3A is a diagram showing direct reflection of light from the object in FIG. 2A, while FIG. 3B shows the corresponding distribution of reflected light usable to correct the distribution of FIG. 2B.

FIG. 4 is a flowchart showing steps of an illustrative method for using multiple optical responses for position detection.

FIG. 5 is a flowchart showing a method of using first and second wavelengths to remove reflected light components from a signal that represents retroreflected light.

FIG. 6 is a diagram showing illustrative computing hardware that can be used in a position detection system and to carry out methods as set forth herein.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment.

In the following detailed description, numerous specific details are set forth to provide a thorough understanding of the subject matter. However, it will be understood by those skilled in the art that the subject matter may be practiced without these specific details. In other instances, methods, apparatuses or systems that would be known by one of ordinary skill have not been described in detail so as not to obscure the subject matter.

Presently-disclosed embodiments include computing systems, methods, and non-transitory computer-readable media embodying code that causes a computing device to carry out embodiments according to the teachings set forth herein.

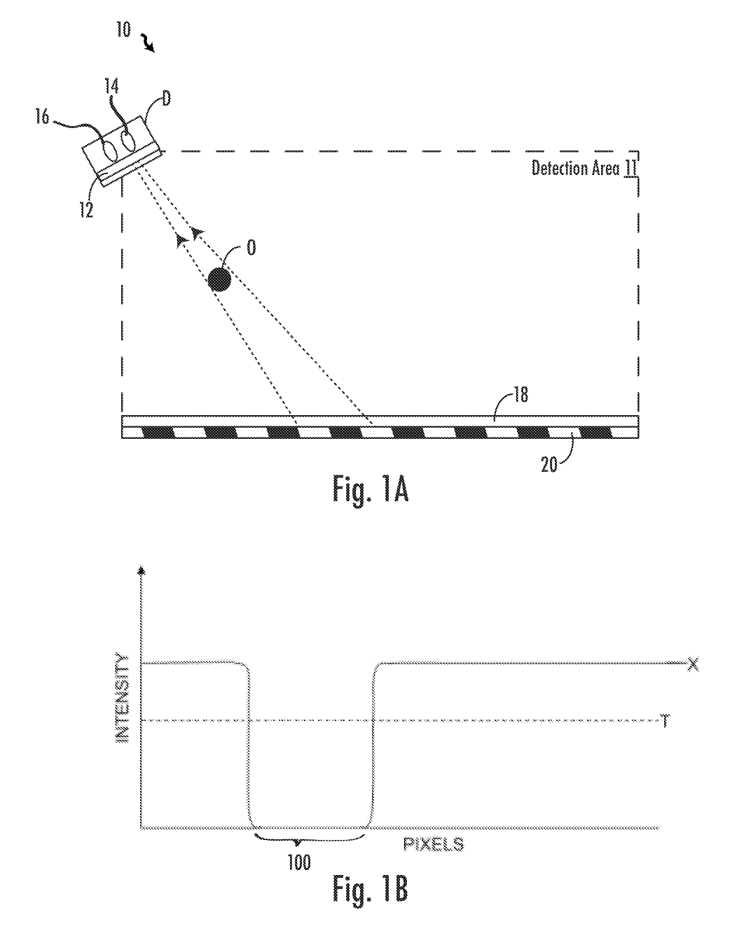

FIG. 1A is a diagram showing an illustrative position detection system 10. In this example, a detection area 11 is defined as an area in which position detection system 10 can be used to detect the presence or absence of one or more objects. Detection area 11 can be used for any purpose. For example, detection area 11 may correspond to a display area of a computing device, a digital whiteboard, or some other area in which data regarding an object's position is to be determined, such as when a user touches the display or other surface, writes with a marker, etc.

Position detection system 10 includes a sensor 12 in an optical detector D that is configured to generate an image of detection area 11 based on light from detection area 11 (i.e., light reflected, refracted, transmitted, or otherwise caused to be directed toward detector D by components of system 10 and/or light reflected, refracted, transmitted, or otherwise caused to be directed toward detector D by one or more objects in detection area 11). Based on signals from sensor 12, processing circuitry (not shown) interfaced to the optical detector D can obtain a signal representing a first pattern of light from the detection area in response to light having a first wavelength being directed into the area, obtain a signal representing a second pattern of light from the detection area in response to light having a second wavelength being directed into the detection area, and produce an output signal by subtracting the signal representing the second pattern of light from the signal representing the first pattern of light. More generally, the processing circuitry uses different optical responses of the detection scene in order to improve accuracy and/or to differentiate between objects in the detection area. The processing circuitry can comprise a microprocessor, digital signal processor (DSP), etc. configured by software and/or may comprise hardware logic that implements the functionality directly using suitably-arranged hardware components.

One sensor 12 is shown here within detector D, but multiple sensors could be used, and multiple detectors could be used as well, such as detectors at two or more corners of detection area 11. Sensor 12 can comprise any suitable detection technology, such as a line or area camera that can produce a signal indicating a spatial distribution of the intensity of light in the space viewed by the sensor. The signal may, for example, comprise a line or array of pixels, though other representations of the imaged light could be used.

As shown in FIG. 1A, position detection system 10 includes an illumination system configured to direct light having the first and second wavelengths into the touch detection area. In this example, the illumination system includes a first light source 14 and a second light source 16 integrated into detector D. Of course, the system could function with one or both sources 14 and/or 16 located outside detector D. First light source 14 is used to provide light having a first wavelength, while second light source 16 is used to provide light having a second wavelength.

In one implementation, first light source 14 comprises an infrared light emitting diode emitting light with a wavelength of 850 nm and second light source 16 comprises an infrared light emitting diode with a wavelength of 980 nm. Other wavelengths can be used, of course.

Generally, the wavelengths are selected so that the touch detection scene (i.e., what is imaged by detector D) provides a different optical response to the different wavelengths. In this example, an at least partially reflective surface 20 is positioned at an edge of detection area 11 so that, in the absence of an object in the detection area, light from the illumination system is returned to sensor 12 in optical detector D. Reflective surface 20 could extend along part or all of one or more edges of the detection area. In some implementations, surface 20 is defined by a bezel surrounding detection area 11.

The position detection system 10 is configured so that more of the light having the first wavelength is reflected from the reflective surface 20 than light having the second wavelength. In this example, the result is achieved by using a filter 18 that attenuates light having the second wavelength but passes light having the first wavelength. In one embodiment reflective surface 20 can comprise a retroreflective member (e.g., an element with retroreflective tape, a coating, or otherwise comprising a material that is retroreflective) at one or more edges of detection area 11. Filter 18 can be positioned between the retroreflective member so as to pass light from source 14 but not source 16 so that light from source 14 is (effectively) not reflected from the edge(s) of detection area 11. Filter 18 and reflective surface 20 are shown as separate elements here, but it will be understood that reflective surface 20 could be formed to fully or completely carry out the filtering function of filter 18.

Next, operation of position detection system 10 is described in more detail.

FIG. 1B is a graph of illumination intensity that shows the expected result when an object O interferes with light in detection area 11, such as when a finger, stylus or other object touches or hovers about a surface in touch area 11. For this example, assume that only light source 14 is used. Object O blocks reflected light (shown by the dashed rays in FIG. 1A) and thus the intensity distribution shown in FIG. 1B features a drop over a portion of the detector corresponding to a width of the shadow cast by object O as shown at 100. When the distribution drops below a threshold level T, suitable position detection operations can be carried out based on the signal from sensor 12 (and other sources as appropriate).

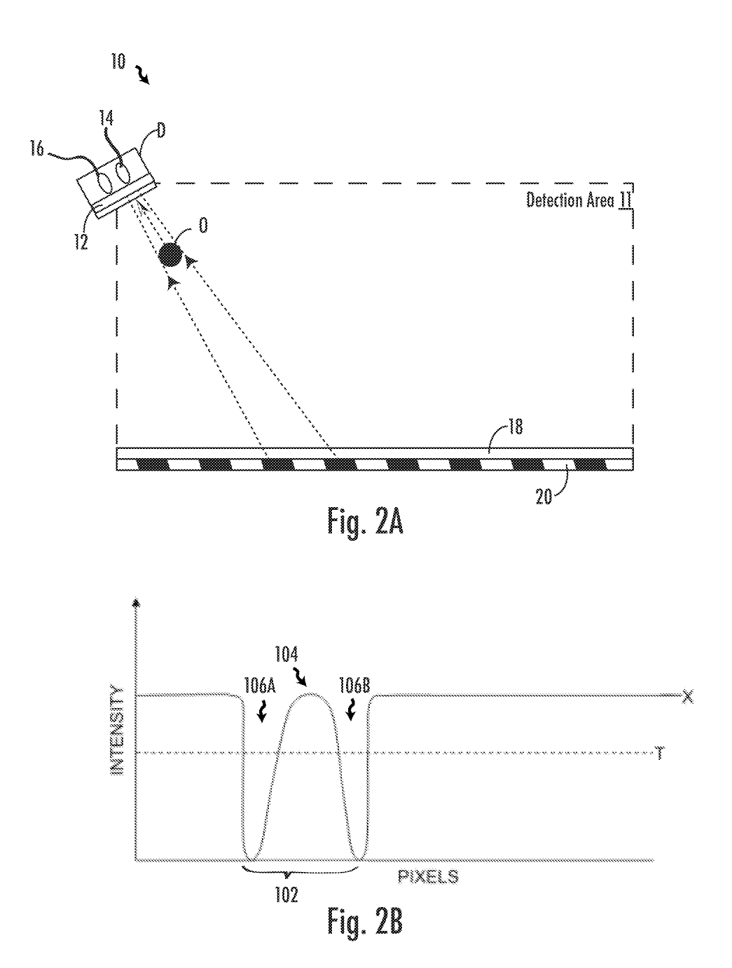

FIG. 2A shows position detection system 10 but with object O at another location, again using only light source 14. As shown in FIG. 2A, due to the proximity of object O, sensor 12 not only collects light reflected from material 20 at an edge of detection area 11, but also some light directly reflected by object O. As shown in the illumination intensity graph “X” of FIG. 2B, the reflected light causes a spike 104 in the detection data over the width of the shadow (the whole width shown at 102). Due to the portions 106A and 106B that remain below threshold T, the position detection system may be confused into calculating two separate touch or other input events—the intensity profile appears to be two shadows.

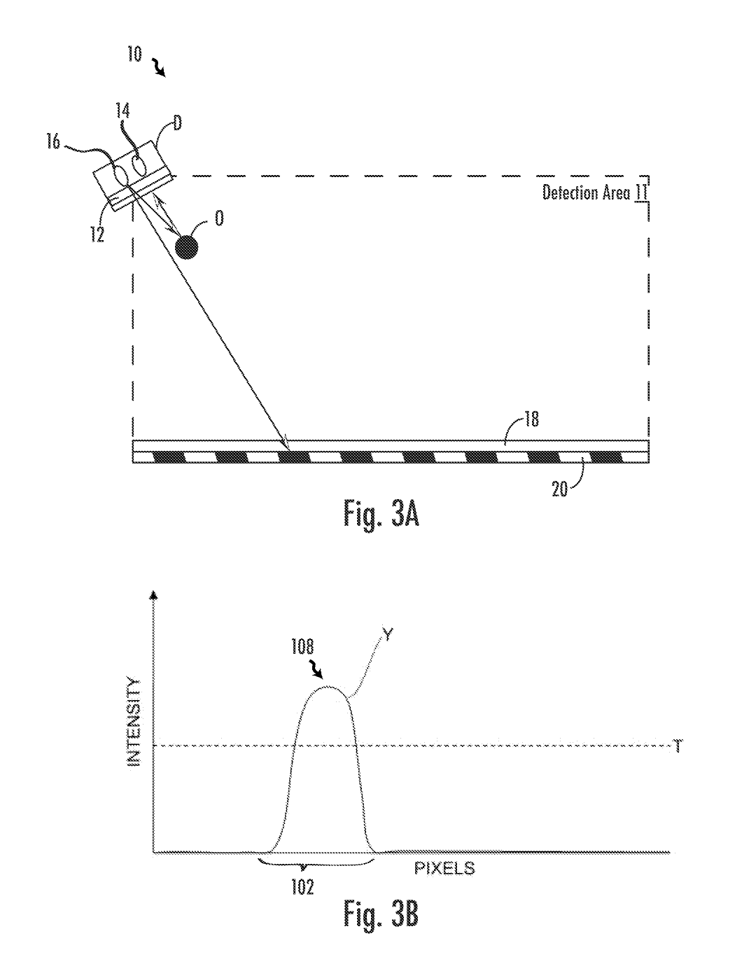

By using an additional optical response, embodiments configured according to the present subject matter can reduce or avoid such errors. FIG. 3A shows position detection system 10, but now using sensor 12 to image the touch detection scene as the scene responds to light from source 16. As indicated by the solid rays, light from source 16 that reaches the edge of detection area 11 is attenuated by filter 18. Thus, as can be seen in the intensity distribution “Y” of FIG. 3B, outside of the portion at 102 that corresponds to the object O, the image intensity is minimal. In practice, the intensity may be zero or non-zero, depending upon how effectively filter 18 attenuates the light. However, as can be seen by the additional rays in FIG. 3A, light is still directly reflected by object O and so intensity distribution “Y” features a spike shown at 108.

Intensity distribution “Y” of FIG. 3B can be used to correct intensity distribution “X” of FIG. 2B to provide a more accurate indication of the touch detection scene. For instance, by subtracting distribution “Y” from distribution “X,” a signal more along the lines of that shown in FIG. 1B can be achieved even when an object is close to detector D.

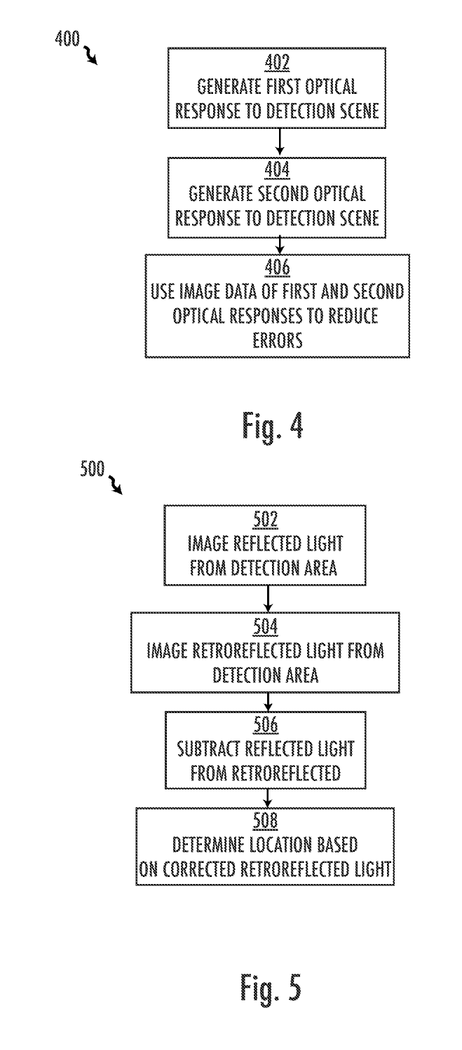

FIG. 4 is a flowchart of an illustrative method 400 for position detection. Block 402 represents generating a first optical response to a detection scene, while block 402 represents generating a second optical response to the detection scene. The two responses should be generated within a close enough time range to sample at a rate that provides meaningful results—for instance, close enough so that any movement of an object into, away from, or within detection area 11 in the time between blocks 402 and 404 will be small enough to be discarded.

As an example, light having a first wavelength can be provided from source 14 of FIGS. 1-3 at block 402 while light having a second wavelength can be provided from source 16 of FIGS. 1-3 at block 404. The intensity of light sources 14 and 16 can be selected so that the intensity of directly-reflected light from each source that reaches the detector matches or is sufficiently close to treat as being the same. However, embodiments can also function with different intensities as between sources 14 and 16 with sufficient correction applied to the respective signals after imaging. Additionally, the intensity of light sources 14 and 16 can be adjusted based on the performance of filter 18.

As another example, a single light source could be used along with bandpass or other filter mechanisms to change the light directed into detection area 11 in order to generate the different optical responses. Still further, in some implementations at least one of the wavelengths is a component in ambient light. In such a case, one or more of the optical responses can be generated by simply deactivating a source used to generate the other optical response, if such a source is even used.

Block 406 represents using image data from the first and second optical responses to reduce detection errors and/or for determining information about the detection scene, such as determining at least one of a location or an identity of one or more objects. For example, as was noted above, the signal representing reflected-only light can be subtracted from the signal representing retroreflected and (depending on object location(s)) reflected light as well. However, the first and second signals could be subjected to other image processing operations to enhance accuracy of the position detection system.

Additionally, the first and second signals can be used to differentiate objects in the detection scene. For example, the position detection system may be configured for use with one or more objects O that respond to different wavelengths as detailed later below.

As another example, block 406 can represent triggering other activity or analysis used to determine a position. For example, a position detection system may rely on the first and second optical responses to identify whether one, two (or more) touch or other events are occurring and use this information in another detection process.

The example in FIG. 4 discusses a first and second optical response and the use of two light sources/wavelengths, but this is not meant to be limiting. For instance, more optical responses could be used to differentiate between multiple objects and/or for correcting detector signals. Multiple different wavelengths could be used to generate the multiple different optical responses. Multiple wavelengths may be directed to the detection area simultaneously and then separately imaged using filtering or other components at one detector and/or separate detectors for different wavelengths.

FIG. 5 is a flowchart showing an example of a method 500 that can be carried out by a processing device in an illustrative implementation of the present subject matter. Block 502 of FIG. 5 represents imaging reflected light from a touch area. For example, block 502 may be carried out by sensor 12 of FIGS. 1-3 when second illumination source 16 is switched on. Block 504 represents imaging retroreflected light from the touch area, and can be carried out by sensor 12 of FIGS. 1-3 when first illumination source 14 is switched on. Block 506 represents subtracting the reflected light from the retroreflected light. For example, if sensor 12 provides line or area images, the values of each respective pixel can simply be subtracted to yield an output signal representing a “corrected” version of the retroreflected light.

Block 508 represents using the corrected version for position detection purposes. For example, based on the portion(s) of the corrected signal at which the light intensity dips below a threshold value, and the relative location and detector optics, the dip in intensity can be mapped to edges or a centerline of a shadow cast by an object on the reflective material imaged by the detector. Using a signal from a second detector, the shadow edges/centerline as between the object and the second detector can be determined, and the object position can be triangulated based on an intersection between the shadow edges and/or centerlines. The details of this approach and other approaches for optical touch detection are known to one of skill in the art.

In addition to or instead of using light of different wavelengths to enhance position detection accuracy, light of different wavelengths can be used to identify different objects based on data representing the objects' response to light of different wavelengths. For example, one or more objects O can be configured with filters and/or retroreflective material so that the objects reflect light of one or more wavelengths but absorb light of other wavelengths. However, depending on the wavelengths and objects used, the principle could be applied to objects without filters or retroreflective material, provided the different optical responses of the object(s) are measurable.

In some implementations, object O of FIGS. 1-3 can comprise a retroreflective material with a filter similar to that described previously. The filter may be configured to allow light from the second light source 16 to pass through. In this manner, the imaging device 12 would receive light retroreflected by the object O and therefore be able to determine that the object 100 is placed upon the display. This would be useful in differentiating the object 100 from another object which does not contain the retroreflective material and filter. A possible use for this system is in the optical interactive whiteboard (an optical interactive whiteboard would be readily understood by a person skilled in the art) environment, whereby the optical imaging device could detect which color or type of pen is placed upon the whiteboard based upon the wavelength of the light retroreflected from the pen. In this embodiment, the amount of light emitters at different wavelengths could be extended to the required amount of types of pen to detect.

As a particular example, a position detection system may be configured to identify a stylus based on identifying one or more of four styli with different reflection properties. Particularly, a first stylus may be configured with a filtered retroreflective material so that its tip does not reflect either a first or second wavelength and thus appears “black” in an image of retroreflected light at the first and second wavelengths. A second stylus can be configured with a filtered retroreflective material to reflect light of the first wavelength but not the second wavelength. A third stylus can be configured with a filtered retroreflective material to reflect light at the second wavelength but not the first. A fourth stylus could be configured with a filtered retroreflective material to reflect light at both the first and second wavelengths. Identifying the styli can allow for drawing with different colors or any other response of the processing components that utilize the identity information.

Presence of one or more of the styli can be determined by imaging the detection scene at the first and second wavelengths and then identifying changes in the resulting image intensity at a given location. For instance the first stylus will cast a shadow resulting in a drop over a portion of the detector corresponding to a width of the shadow in both the first and second images. The second stylus will cast a shadow resulting a drop over a portion of the detector corresponding to a width of the second stylus's shadow in the image from the second wavelength but not in the image from the first wavelength (because the second stylus reflects light of the first wavelength). The third stylus will cast a shadow resulting a drop over a portion of the detector corresponding to a width of the third stylus's shadow in the image from the first wavelength but not in the image from the second wavelength.

The fourth stylus will not cast a shadow in the same manner as the other styli; however, the detection system can be configured to compare the intensity at a given location in both the first and second images to determine if there is an expected variance at the same location in both images as compared to the intensity when no stylus at all is present. The expected variance between the intensity with no stylus and when the fourth stylus is present may be the same in both images or may differ for images of different wavelengths. If the expected variance (or variances) is/are found to appear at the same location, that location can correspond to the location of the fourth stylus. The retroreflective material and/or filter of the fourth stylus can be configured to cause a detectable, but not full, change in intensity in some implementations to aid in detecting the expected variance.

The example above was for purposes of illustration only. More styli could be identified with additional wavelengths and expected responses, and of course the principle can be applied to any object usable with the position detection system. The principle can be used to identify one or multiple objects in a given detection scene.

More generally, the position detection system can be configured to generate a set of optical responses by generating multiple images, each image corresponding to light of a different wavelength from the detection area. Based on comparing a selected portion of the image (i.e., detection signal, such as one or more particular portions along the length of a line detector or area(s) in an area detector) across the set of optical responses, the position detection system can identify whether an expected intensity pattern is found (e.g., shadow/shadow, shadow/no shadow, no shadow/shadow, variance/variance of the example above) and based on the intensity pattern, identify an object at a position in the detection area that corresponds to the selected portion of the image. The object can be identified by matching the intensity pattern against intensity patterns associated with the various objects—for instance, a detection routine can store a set of data correlating intensity patterns to object identities and access the library to determine if an intensity pattern matches one of the known patterns.

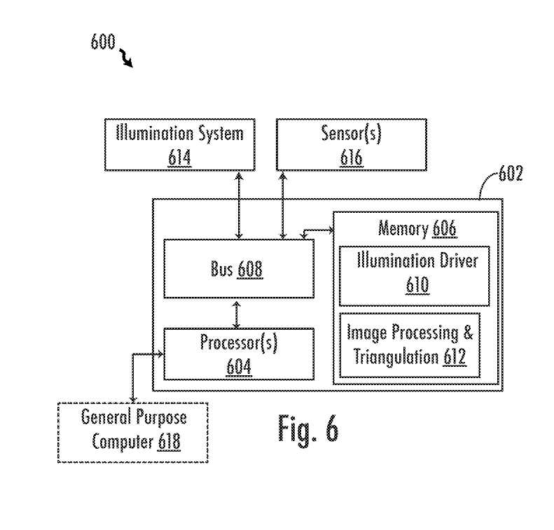

FIG. 6 is a diagram showing an illustrative computing system 600 configured to carry out position detection according to the present subject matter. For example, system 600 can carry out methods according to FIGS. 4-5 and otherwise operate to perform as discussed herein. In this example, a computing device 602 features one or more processors 604 connected to a memory 606 via bus 608, which represents internal connections, buses, interfaces, and the like, and also provides communication with external components. Memory 606 represents RAM, ROM, cache, magnetic, or other non-transitory computer-readable media and embodies program instructions that configure what processor 604 does. In this example, an illumination driver routine 610 is embodied along with an image processing and triangulation routine 612; in practice, the routines could be part of the same process or application or could be separate.

Illumination driver 610 causes processor 604 to send signals to illumination system 614 to drive the illumination system to provide different illumination in the detection area. For example, illumination system 614 may comprise sources 14 and 16 of FIGS. 1-3, driven to provide the first and second wavelengths. Image processing and triangulation routine 612 causes processor 604 to read one or more sensors (e.g., sensor 12 of FIGS. 1-3 and/or other sensors in additional detectors D if multiple detectors D are used) and to correct the sensor data based on the varying illumination. Triangulation can be carried out based on the corrected signals as noted above (i.e., by determining where multiple shadows cast by an object intersect).

As discussed above, embodiments may use different wavelengths for object identification purposes in addition to or instead of using the different wavelengths to enhance the ability to determine the location of objects. Thus, memory 606 may embody suitable routines to identify objects based on the sensor data and the known information about the response of one or more objects to the different wavelengths of light as noted above.

Computing device 602 may comprise a digital signal processor (DSP) or other circuitry included in or interfaced to detectors D and then interfaced to a general purpose computer 618 (e.g., a desktop, laptop, tablet computer, a mobile device, a server, an embedded device, a computer supporting a digital whiteboard environment, etc.) via suitable connections (e.g., the universal serial bus (USB)). For example, a display device or digital whiteboard may include the illumination sources, sensor(s), and processing circuitry and can be adapted for integration with computer 618.

However, illumination driver routine 610 and/or triangulation 612 could be carried out by computer 618 itself (which itself comprises a processor, memory, etc. or other suitable processing electronics), with illumination system 614 and sensor 616 commanded directly by computer 618 or through a suitable driver chip or circuit.

More generally, the present subject matter can be implemented by any computing device that carries out a series of operations based on commands. This includes general-purpose and special-purpose processors that access instructions stored in a computer-readable medium that cause the processor to carry out operations as discussed herein as well as hardware logic (e.g., field-programmable gate arrays (FPGAs), programmable logic arrays (PLAs), application-specific integrated circuits (ASICs)) configured to carry out operations as discussed herein.

Embodiments of the methods disclosed herein may be performed in the operation of computing devices. The order of the blocks presented in the examples above can be varied—for example, blocks can be re-ordered, combined, and/or broken into sub-blocks. Certain blocks or processes can be performed in parallel.

Any suitable non-transitory computer-readable medium or media may be used to implement or practice the presently-disclosed subject matter, including, but not limited to, diskettes, drives, magnetic-based storage media, optical storage media (e.g., CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A device, comprising:
an optical detector configured to generate an image representing light from a detection area; and
processing circuitry interfaced to the optical detector and configured to:
obtain a signal representing a first pattern of light from the detection area in response to light having a first wavelength being directed into the area,
obtain a signal representing a second pattern of light from the detection area in response to light having a second wavelength being direct into the detection area, and
produce an output signal by subtracting the signal representing the second pattern of light from the signal representing the first pattern of light.

2. The device of claim 1, further comprising an illumination system configured to direct light having the first and second wavelengths into the touch detection area.

3. The device of claim 2, further comprising:
a reflective surface positioned at an edge of the detection area so that, in the absence of an object in the detection area, light from the illumination system is returned to the optical detector,
the reflective surface configured so that more of the light having the first wavelength is reflected from the reflective surface than light having the second wavelength.

4. The device of claim 3, wherein the reflective surface is configured by a filter that attenuates light having the second wavelength.

5. The device of claim 1, further comprising:
a processor configured to access the output signal and, based at least in part on the output signal, determine a coordinate of an object in the detection area.

6. The device of claim 1, wherein the touch detection area corresponds to an area of a display of a computing device.

7. The device of claim 1, wherein the touch detection area corresponds to a digital whiteboard.

8. A method, comprising:
receiving, by a detector, light representing a first optical response of a detection scene and generating a first detection signal;
receiving, by the detector, light representing a second optical response of the detection scene and generating a second detection signal; and
based on the light representing the first and second optical responses, determining at least one of a location of an object in the detection scene or an identity of an object in the detection scene.

9. The method of claim 8,
wherein the light representing the first optical response comprises light reflected by a member at an edge of a detection area and the light representing the second optical response comprises light directly reflected by the object.

10. The method of claim 9, wherein determining the location of the object comprises removing a component in a first detection signal, the removed component corresponding to light directly reflected by the object.

11. The method of claim 10, wherein determining the location of the object comprises determining a shadow cast by the object and triangulating the location based on the shadow position.

12. The method of claim 8, further comprising:
generating the first optical response by directing light having a first wavelength into the detection scene and generating the second optical response by directing light having a second wavelength into the detection scene.

13. The method of claim 8, wherein determining at least one of a location of an object in the detection scene or an identity of an object in the detection scene comprises determining an identity of the object based on differences between a first detection signal representing the first optical response and a second detection signal representing the second optical response and an optical characteristic of the object.

14. The method of claim 13, wherein determining the identity of the object comprises comparing a selected portion of the image as represented in the first and second detection signals to determine whether the signals show an intensity pattern that matches an expected intensity pattern caused by the optical characteristic of the object.

15. A position detection system, comprising:
a reflective member positioned along at least part of at least one edge of a detection area, the reflective member configured to reflect light of a first wavelength and to attenuate light of a second wavelength;
a detector positioned to image at least the reflective member; and
an illumination system configured to direct light having the first wavelength and the second wavelength into the detection area.

16. The position detection system of claim 15, wherein the illumination system comprises:
a first light emitting diode that provides the light having the first wavelength; and
a second light emitting diode that provides the light having the second wavelength.

17. The position detection system of claim 15, wherein the reflective member comprises a retroreflective material and is configured to attenuate light of the second wavelength by a filter material.

18. The position detection system of claim 15, interfaced to a processing device configured to:
obtain a first image comprising light reflected from the detection area in response to light having the first wavelength;
obtain a second image comprising light directly reflected by an object other than the reflective material positioned along the at least one edge; and
use the second image to reduce an effect, in the first image, due to the light directly reflected by the object.

19. The position detection system of claim 15, integrated into a display device.

20. The position detection system of claim 15, integrated into a digital whiteboard.

21. A method, comprising:
receiving, by a detector, light representing a first optical response of a detection scene and generating a first detection signal;
receiving, by the detector, light representing a second optical response of the detection scene and generating a second detection signal; and
based on the light representing the first and second optical responses, determining, by processing hardware interfaced to the detector, an identity of an object in the detection scene by comparing a selected portion of a first image representing the first optical responds with a corresponding portion of a second image representing the second optical response and, based on the comparison, identifying whether an expected intensity pattern is found, the identity of the object being an identity associated with the expected intensity pattern.

22. The method of claim 21, wherein determining an identity of an object comprises determining an identity of each of multiple objects, each of the multiple objects at a different portion of the first and second images.

23. The method of claim 21, wherein the detection scene includes at least one object that reflects light of a first wavelength used in generating the first optical response, the object responding to light of a second wavelength used in generating the second optical response by reflecting less light of the second wavelength as compared to light of the first wavelength.

24. The method of claim 23, wherein the object is configured with a filter to attenuate light of the second wavelength.

25. The method of claim 21,
wherein the light representing the first optical response comprises light indicating a shadow cast by the object in the detection area when light of a first wavelength is directed into the detection area,
wherein the light representing the second optical response comprises light reflected by the object in the detection area when light of a second wavelength is directed into the detection area, and
wherein the object's identity is determined by identifying the shadow in the first image and identifying absence of the shadow at a corresponding location in the second image.
